(19) United States
(12) Patent Application Publication
(10) Pub. No.: US 2010/0301274 A1
(43) Pub. Date: Dec. 2, 2010

(54) Method For Producing Synthesis Gas by Steam Reforming

(75) Inventors: Jean Gallarda, Joinville Le Pont (FR); Jacques Segret, Paris (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exploitation Des Procedes Georges Claude, Paris (FR)

(21) Appl. No.: 12/744,950

(22) PCT Filed: Nov. 26, 2008
(86) PCT No.: PCT/FR08/52127

§ 371 Date: May 27, 2010

(30) Foreign Application Priority Data
Dec. 3, 2007 (FR) 0759498

(51) Int. Cl. C01B 3/26

(52) U.S. Cl. 252/373

(57) ABSTRACT

The present invention relates to a process for the steam reforming of a hydrocarbon mixture in order to produce synthesis gas.

The present invention relates to a process for the steam reforming of a hydrocarbon mixture in order to produce synthesis gas.

A steam hydrocarbon reforming process is carried out in a steam reforming furnace supplied on the one hand with a hydrocarbon feed and steam and on the other hand with heat.

The heat is generally provided by the combustion of various fuels with air. This combustion is carried out in the radiant section of the furnace, sometimes also called the combustion chamber, thanks to burners placed in the top and/or in the bottom and/or on the side walls of the radiant section. When the burners are placed in the top of the furnace, the reactor is said to be top-fired and when the burners are placed in the side walls, the reactor is said to be side-fired.

The reforming is carried out in the combustion chamber of the furnace, which comprises burners and catalyst-filled tubes through which the hydrocarbon feed and the steam, generally in the form of a mixture, can pass.

The burners are placed for optimum combustion heat transfer to the hydrocarbon of the steam mixture through the wall of the tubes.

When the furnace is hot, the feed is injected. The high temperature of the furnace, namely several hundred degrees, maintained thanks to the combustion, therefore allows the molecules of the hydrocarbon feed to undergo the dissociation reaction in the tubes, with production of synthesis gas (also called syngas) which will then be treated.

High temperatures are always desirable for increasing the synthesis gas yield.

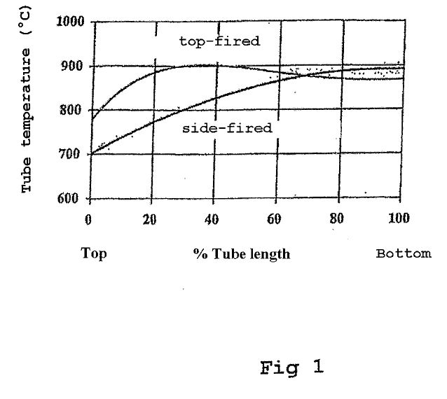

Owing to the geometry of the reforming furnace and to the way in which the reforming reactions take place, the temperature is not uniform along a tube, and the temperature profiles are very different depending on whether the tubes are top-fired or side-fired. Thus, in the case of tubes with which a side-fired reformer is equipped, the maximum temperature, i.e. 900° C., is observed in the downstream portion of the tube, whereas in the case of a tube with which a top-fired reformer is equipped, the maximum temperature, i.e. 900° C., is observed in the upstream portion of the tube. The upstream and downstream portions of the tubes are defined with respect to the direction of injection of the steam/hydrocarbon mixture into the tubes. These various temperature profiles are illustrated in FIG. 1, which shows the wall temperature profiles of the tubes in degrees Celsius, along the length of the tubes from the top of a tube (0% of the length) to its bottom end (100% of the length). Thus, it may be seen that the temperature of a side-fired tube increases from 700° C. to 900° C., the maximum temperature, i.e. 900° C., being observed in the downstream portion of the tube. In the case of a tube with which a top-fired reactor is equipped, the temperature is around 800° C. at the top of the tube, passes through the maximum (900° C.) in the first half and then decreases down to about 850° C.

Reformer tubes usually have a lifetime of about 100 000 hours under normal conditions of use. Higher temperatures than planned reduce the lifetime of the tubes: thus, the lifetime may be reduced by a factor of 2 if the tube is used at a temperature of 15° C. higher than its design temperature.

Various solutions are used, separately or in combination, in order to control the aging of the reforming tubes. These include, for example:

preventing excessive damage of the tubes by controlling the process employed in the furnace so as to apply a sufficient temperature to maintain a high synthesis gas yield, while still ensuring that this temperature does not reduce the lifetime of the reforming tubes using a method described in Patent Application FR 06/55308 (not published);

continuously determining effective remaining lifetime of the tubes of a reformer, for each tube, so as to program their replacement according to the method described in International Application PCT/FR2007/050635 (not published); and

preventing hot spots on the tubes, for example by improving the power distribution along the tubes.

Another response to the permanent need of reducing the cost associated with replacing the reformer tubes would consist in increasing the planned lifetime of these tubes under normal conditions of use.

The object of the present invention is to provide a process enabling, under the same conditions of use, the lifetime of the tubes to be increased while maintaining the normal operating temperatures of said tubes.

For this purpose, the invention relates to a process for producing synthesis gas by steam hydrocarbon reforming carried out in a combustion chamber of a reforming furnace comprising burners and tubes, said tubes being filled with catalyst and placed vertically in the combustion chamber, through which tubes a mixture of said hydrocarbons with steam passes, said mixture being introduced into the tubes at their upper ends, the synthesis gas produced being recovered partly at the bottom of the tubes, the burners being placed so as to transfer the heat from the combustion to the hydrocarbon/steam mixture through the wall of the tubes, characterized in that, after the tubes have been operated for a given time, they are inverted so as to increase their expected lifetime under normal conditions of use.

Specifically, by inverting the reformer tubes at the end of a certain period of operation, the uniformity of aging of the tubes over their length is improved, whether these be tubes of a side-fired reactor or a top-fired reactor. By inverting a tube, the region of the tube exposed to the highest temperatures, in which the aging is consequently the greatest, becomes, after this inversion, a region exposed to lower temperatures and therefore undergoes aging more slowly. Although the process is particularly advantageous in the case of tubes with which side-fired reformers are equipped, since, during tube inversion, the lowering in temperature may be up to 200° C., it is also quite appreciable in the case of a top-fired reformer. In the case of a top-fired reformer, the hottest point (900° C.) will be in fact subjected, after tube inversion, to a temperature 15 to 20° C. lower, thereby doubling the lifetime under the same operating conditions.

A variant of the invention relates to a process in which the operating time after which the tubes are inverted is determined according to the average reforming temperature. This is because, depending on whether the reforming temperature is higher or lower, the wall temperature of the tubes is itself higher or lower, and the lifetime of the tubes and the aging of the tubes are affected thereby. Likewise, the reformer feed has an influence on the lifetime of the tubes in their entirety: when the feed is less, it is unnecessary to supply as much heat to the reformer, and in this case tube aging is less; in contrast, if the feed is increased, the heat supply must be increased, which accelerates tube aging. Thus, it is preferable to determine the period of operation after the tubes have been inverted as a function of the feed supplying the reformer.

All the tubes may be inverted in a single operation during a programmed shutdown of the reforming plant. This general inversion during a programmed shutdown of the plant will advantageously take place during the second half of the tube life. Thus, for a calculated tube lifetime (inversion excluded) of 10 years, the tubes will be inverted during a programmed shutdown after 5 years of life of the tubes.

Another variant of the invention relates to a process in which the accelerated aging of certain tubes due to their position in the furnace is taken into account for carrying out their anticipated inversion. Therefore all the tubes are not treated in the same way—the prematurely inverted tubes will consequently have to be changed independently of the rest of the tubes of the reformer.

Preferably, the tube inversion process is used jointly with a method of monitoring the aging of the tubes, and in the event of accelerated aging of certain tubes being demonstrated, selective inversion of these prematurely aged tubes takes place and, if necessary, they are subsequently changed.

The process of the invention applies to existing plants and in this case it may be necessary to cut a tube in the immediate proximity of its two ends, then to invert said tube and to weld it to the ends that have remained in place.

However, it is preferable to use tubes having a particular geometry at the ends, either by the ends themselves or via junction pieces so that the tubes can be inverted without it being necessary to cut them.

1-5. (canceled)

6. A process for producing synthesis gas by steam hydrocarbon reforming carried out in a combustion chamber of a reforming furnace comprising burners and tubes, said process comprising:
filling said tubes with catalyst,
placing said filled tubes vertically in the combustion chamber, said tubes having walls, an upper end and a lower end,
passing a mixture of said hydrocarbons with steam through said tubes,
introducing said mixture into the tubes at said upper ends,
removing the synthesis gas produced partly at said tube bottom end,
placing the burners so as to transfer the heat from the combustion to the hydrocarbon/steam mixture through said tube walls, and
inverting the tubes, at the end of a first period of operation, so as to increase their expected lifetime under normal conditions of use.

7. The process of claim 6, wherein said furnace has an average reforming temperature, wherein said first period of operation is determined according to the average reforming temperature.

8. The process of claim 6, wherein all the tubes are inverted in a single operation during a programmed shutdown.

9. The process of claim 6, wherein the accelerated aging of certain tubes due to their position in the furnace is taken into account for carrying out their anticipated inversion.

10. The process of claim 6, in which said process is used jointly with a method of monitoring the aging of the tubes and, in the event of accelerated aging of certain tubes being demonstrated, selective inversion of the prematurely aged tubes takes place.
